(19) United States
(12) Patent Application Publication
(10) Pub. No.: US 2026/0342430 A1
(43) Pub. Date: Oct. 29, 2026

(54) WIRELESS COMMUNICATION SYSTEM, CENTRAL CONTROL DEVICE AND WIRELESS COMMUNICATION METHOD

(71) Applicant: NTT, INC, Tokyo (JP)

(72) Inventors: Masaki SHIMA, Musashino-shi, Tokyo (JP); Fumihiro YAMASHITA, Musashino-shi, Tokyo (JP); Takeshi ONIZAWA, Musashino-shi, Tokyo (JP)

(73) Assignee: NTT, Inc., Tokyo (JP)

(21) Appl. No.: 19/114,481

(22) PCT Filed: Sep. 26, 2022
(86) PCT No.: PCT/JP2022/035658

§ 371 Date: Mar. 24, 2025

(51) Int. Cl. H04B 7/185; G01W 1/10; H04B 7/155

(52) U.S. Cl. CPC H04B 7/18513; H04B 7/155; H04B 7/18543; G01W 1/10

(57) ABSTRACT

The wireless communication system of the present disclosure includes a plurality of ground wireless stations and a plurality of upper-air wireless stations that perform wireless communication with the ground wireless stations by one-to-one feeder links while moving in the sky including outer space or moving in the sky including outer space but being relatively stationary with respect to the ground. The wireless communication system is configured to execute processing of calculating combinations of the feeder links between the ground wireless stations and the upper-air wireless stations, processing of calculating data rates respectively for the feeder links represented by the combinations, processing of calculating a total value of the data rates for each of the combinations, and processing of switching the feeder links to the combination in which the total value becomes a maximum.

### CROSS-REFERENCE TO RELATED APPLICATION

The present application is based on PCT filing PCT/JP2022/035658, filed Sep. 26, 2022, the entire content of which is incorporated herein by reference.

### FIELD

The present disclosure relates to a wireless communication system using a non-terrestrial network, a central control device, and a wireless communication method.

### BACKGROUND

With recent spread of 4G/5G services, and the like, demand for use of a communication band of a network is increasing year by year. In addition, further reduction in communication delay is also required for future B5G/6G services. In the B5G/6G services, a non-terrestrial network (NTN) is expected to be used to expand a coverage area (see, for example, Non Patent Literature 1). Here, a communication system has been conceived, which uses, as a service link wireless station (hereinafter, referred to as an upper-air wireless station), a mobile body that moves in the sky including outer space, or a stopping mobile body/aerial floating body that moves in the sky including outer space but seems to be relatively stationary with respect to the ground.

Furthermore, in recent years, a method has been devised in which an upper-air network in which a plurality of upper-air wireless stations are interconnected by wireless communication or optical signal communication is configured, and a transmission radio wave from a mobile terminal on the ground is connected to the ground wireless station by relay of the upper-air network.

As an example of the upper-air wireless station, a geostationary orbit (GEO) satellite or a low earth orbit (LEO) satellite capable of performing wireless communication with a larger capacity and a lower delay than the GEO satellite and located in a low earth orbit with an orbital altitude of 2000 km or less is known (see, for example, Patent Literature 1). Furthermore, a high altitude platform system (HAPS), or the like, capable of further increasing a capacity and reducing a delay than the LEO satellite is known.

In a feeder link which is wireless communication between an upper-air wireless station and a ground wireless station, use of a millimeter wave wireless band is required in order to secure a wireless band necessary for large-capacity communication.

However, in the millimeter wave wireless band, it is known that attenuation of wireless signals due to rainfall, clouds, and water vapor is large. When the millimeter wave wireless band is used for the above-described feeder link, site diversity for selecting a link switching destination from a plurality of ground wireless stations is required in a region with a large precipitation amount. Alternatively, a satellite diversity for selecting a link switching destination from a plurality of upper-air wireless stations is required (see, for example, Non Patent Literature 2).

In addition, depending on regions, a rainfall range and a cloud ceiling range are wide depending on seasons, and in recent years, local downpour has frequently occurred. Thus, in a region where measures against rainfall are particularly necessary, in order to increase selection candidates of site diversity, measures are taken to increase an operating rate of the feeder link by adding ground wireless stations separated from each other until correlation with rainfall or cloud sky decreases.

As described above, in the related art, about one or two upper-air wireless stations and a plurality of ground wireless stations separated from each other are arranged until there is no correlation with rainfall. Here, site diversity and satellite diversity are performed under a one-to-n redundancy switching scheme in which one ground wireless station is a currently working system and the other n ground wireless stations are standby systems (see, for example, Patent Literature 2, Patent Literature 3, and Non Patent Literature 2).

In the related art, if a reception signal is attenuated due to rainfall, or the like, and the currently working line is disconnected, the standby ground wireless station detects the disconnection of the currently working line via the ground network. Then, the system automatically or the operator manually performs link switching control to an auxiliary system according to priority of a link switching destination determined in advance. This makes it possible to prevent service interruption due to rainfall, or the like, under a simple control/operation method.

Note that, with respect to rainfall prediction in Japan, precipitation intensity prediction is performed every 250 m mesh or every 1 km mesh based on high-resolution precipitation Nowcast data provided by the Japan Meteorological Agency (see, for example, Non Patent Literature 3).

### CITATION LIST

### Patent Literature

Patent Literature 1: JP 2001-086054 A

Patent Literature 2: JP 2007-529964 A

Patent Literature 3: JP 2014-053751 A

### Non Patent Literature

Non Patent Literature 1: 3rd Generation Partnership Project; Technical Specification Group Radio Access Network; Solutions for NR to support non-terrestrial networks (NTN)(Release 16), 38.821, V 16.1.0 (2021-05).

Non Patent Literature 2: Improvement Factor of Ku-Band Satellite Diversity Effects Related to Rain Area Motion, IEICE Technical Report. A. P, Antenna propagation 108(148) 35-40, 2008-07-16.

Non Patent Literature 3: Japan Meteorological Agency, High-resolution Precipitation Nowcast https://www.jma.go.jp/jma/kishou/know/kurashi/highres_nowcast. html

### SUMMARY

### Technical Problem

However, in the related art, there is a problem that facilities of the auxiliary system are not effectively used and facility cost increases. Furthermore, if it is tried to support an upper-air network in which a plurality of upper-air wireless stations are connected by wireless communication or optical signal communication according to the one-to-n redundancy switching scheme in the related art, (m×n) ground wireless stations are required for m upper-air wireless stations. Thus, there is a problem that the facility cost of the ground wireless stations further increases.

In order to solve the above-described problem, a first object of the present disclosure is to provide a wireless communication system capable of improving a data rate of wireless communication in an NTN by effectively using facilities of ground wireless stations and upper-air wireless stations.

In addition, a second object of the present disclosure is to provide a central control device capable of improving a data rate of wireless communication in an NTN by effectively using facilities of ground wireless stations and upper-air wireless stations.

In addition, a third object of the present disclosure is to provide a wireless communication method capable of improving a data rate of wireless communication in an NTN by effectively using facilities of ground wireless stations and upper-air wireless stations.

### Solution to Problem

A first aspect of the present disclosure is a wireless communication system that performs communication using a non-terrestrial network, the wireless communication system including:
a plurality of ground wireless stations;
a plurality of upper-air wireless stations that perform wireless communication with the ground wireless stations by one-to-one feeder links while moving in the sky including outer space or while moving in the sky including outer space but being relatively stationary with respect to the ground,
in which the wireless communication system is preferably configured to execute:
combination calculation processing of calculating combinations of the feeder links between the ground wireless stations and the upper-air wireless stations;
data rate calculation processing of calculating data rates respectively for the feeder links indicated by the combinations;
total value calculation processing of calculating a total value of the data rates for each of the combinations; and
link switching processing of switching the feeder link to the combination in which the total value becomes a maximum.

A second aspect of the present disclosure is a central control device that controls feeder links to be established between:
a plurality of ground wireless stations; and
upper-air wireless stations that perform wireless communication while moving in the sky including outer space or while moving in the sky including outer space but being relatively stationary with respect to the ground,
the central control device being preferably configured to execute:
combination calculation processing of calculating combinations of the feeder links between the ground wireless stations and the upper-air wireless stations;
data rate calculation processing of calculating data rates respectively for the feeder links indicated by the combinations;
total value calculation processing of calculating a total value of the data rates for each of the combinations; and
processing of transmitting a control message including information on the combination in which the total value becomes a maximum to the plurality of ground wireless stations.

A third aspect of the present disclosure is a wireless communication method for performing communication using a non-terrestrial network including:
a plurality of ground wireless stations; and
a plurality of upper-air wireless stations that perform wireless communication with the ground wireless stations by one-to-one feeder links while moving in the sky including outer space or while moving in the sky including outer space but being relatively stationary with respect to the ground,
the wireless communication method preferably including:
combination calculation processing of calculating combinations of the feeder links between the ground wireless stations and the upper-air wireless stations;
data rate calculation processing of calculating data rates respectively for the feeder links indicated by the combinations;
total value calculation processing of calculating a total value of the data rates for each of the combinations; and
link switching processing of switching the feeder link to the combination in which the total value becomes a maximum.

### Advantageous Effects of Invention

According to the first to third aspects of the present disclosure, it is possible to provide a wireless communication system, a central control device, and a wireless communication method capable of effectively using facilities of ground wireless stations and upper-air wireless stations and improving a data rate of wireless communication in an NTN.

### BRIEF DESCRIPTION OF DRAWINGS

FIG. 1 is a configuration example of a wireless communication system according to a first embodiment of the present disclosure.

FIG. 2 is a schematic view illustrating a state in which upper-air wireless stations move in the sky in the wireless communication system according to the first embodiment of the present disclosure.

FIG. 3 is a view for explaining a role of a central control device according to the first embodiment of the present disclosure.

FIG. 4 is a block diagram illustrating a functional configuration example of the central control device according to the first embodiment of the present disclosure.

FIG. 5 is a block diagram illustrating a functional configuration example of a ground wireless station according to the first embodiment of the present disclosure.

FIG. 6 is a configuration example of an upper-air network according to the first embodiment of the present disclosure.

FIG. 7 is a block diagram illustrating a functional configuration example of a communication function of the upper-air wireless station according to the first embodiment of the present disclosure.

FIG. 8 is a flowchart of processing to be executed by the central control device according to the first embodiment of the present disclosure.

### DESCRIPTION OF EMBODIMENTS

### First Embodiment

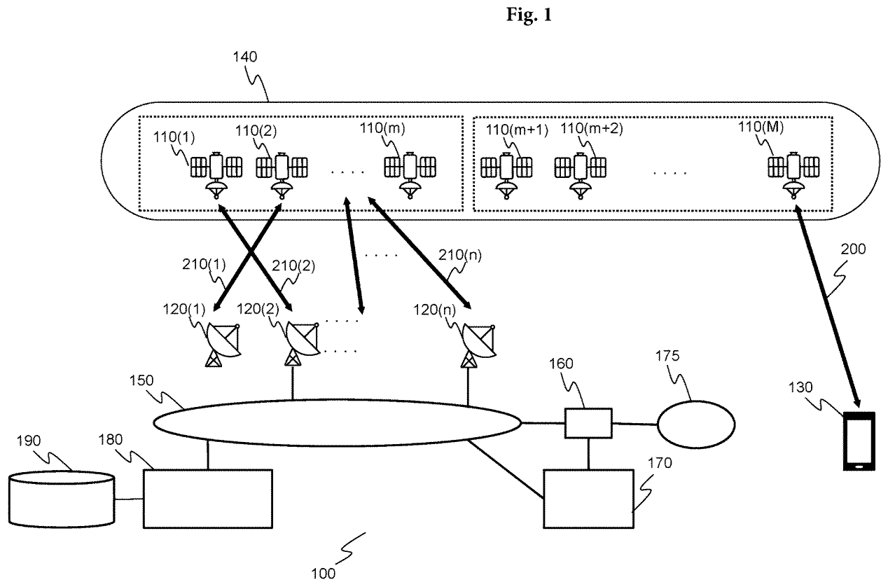

FIG. 1 is a configuration example of a wireless communication system according to a first embodiment of the present disclosure. A wireless communication system 100 includes M upper-air wireless stations 110(1), 110(2), . . . , 110(M) and n ground wireless stations 120(1), 120(2), . . . , 120(n), where M≥2 and m≥2.

Note that, hereinafter, in a case where description is common to all the upper-air wireless stations 110(1), 110(2), . . . , 110(M), they are referred to as an upper-air wireless station 110 with (number) at the end of the reference numeral omitted. Only in a case where a specific upper-air wireless station 110 is referred to, (number) is added to the end of the reference numeral and described like an upper-air wireless station 110(1). In addition, the ground wireless station 120 and a plurality of components appearing thereafter will be similarly described.

The upper-air wireless station 110 is a wireless relay station that moves in the sky including outer space or moves in the sky including outer space but seems to be relatively stationary with respect to the ground. The upper-air wireless station 110 is, for example, a GEO satellite communication station, a medium earth orbit (MEO) satellite communication station, or an LEO satellite communication station. Each of the upper-air wireless stations 110 performs wireless communication with a ground mobile station 130 via a service link and relays a radio wave transmitted from the ground mobile station 130 to an upper-air network.

The ground mobile station 130 is a wireless terminal such as a smartphone that performs wireless communication with the upper-air wireless station 110. The ground mobile station 130 transmits and receives packet data such as Internet traffic to and from the upper-air wireless station 110 via the service link 200.

An upper-air network 140 is a communication network formed by M upper-air wireless stations 110 connected to each other by wireless communication or optical signal communication. The upper-air network 140 relays packet data received by each of the upper-air wireless stations 110 from the ground mobile station 130 to the upper-air wireless station 110 capable of communicating with the ground wireless station 120 via one or more upper-air wireless stations 110.

The ground wireless station 120 receives a radio wave transmitted from the upper-air wireless station 110 capable of communicating with the ground wireless station 120 and transmits packet data included in the radio wave to a ground network 150. In other words, the ground wireless station 120 functions as a gateway station of the ground network 150.

The ground network 150 is a network constituted with ground lines, including a transmission path such as an optical fiber, a wireless base station, a wireless relay station, and the like.

A user plane function (UPF) 160 is a portion that performs transmission/reception processing of a packet of user data.

A core network 170 is a backbone communication network of a 5G mobile communication system that connects exchanges and is connected to the Internet or another communication network.

A data network (DN) 175 is an external network such as the Internet to which the core network 170 is connected via the UPF 160.

A central control device 180 is a portion that determines a connection combination of lines in wireless communication between the upper-air wireless station 110 and the ground wireless station 120 via the ground network 150 and performs link switching control.

A weather forecast data distribution system 190 is an external system that performs weather prediction at regular time intervals and distributes weather prediction data. For example, the weather forecast data distribution system 190 is a weather information distribution system (high-resolution precipitation Nowcast data) of Japan Meteorological Business Support Center described in Non Patent Literature 3.

A feeder link 210 is a wireless communication line established between the upper-air wireless station 110 and the ground wireless station 120 under the control of the central control device 180. There is only one ground wireless station to which one upper-air wireless station 110 can be wirelessly connected and a transmission speed can be allocated at the same time. In other words, the feeder link 210 is a one-to-one communication line.

Thus, in a case where there are n ground wireless stations 120 as illustrated in FIG. 1, the number of feeder links 210 to be established is n at the maximum. Also in FIG. 1, feeder links 210(1), 210(2), . . . , 210(n) are established.

Here, the upper-air wireless station 110 can neither establish wireless connection with the ground wireless station 120 nor establish the feeder link 210 unless approaching above the ground wireless station 120. FIG. 1 illustrates a state in which m upper-air wireless stations 110 among the M upper-air wireless stations 110 approach above the ground wireless station 120. The m upper-air wireless stations 110 function as gateway stations of the upper-air network 140.

As described above, in the wireless communication system 100 of the present disclosure, the plurality of upper-air wireless stations 110 form the upper-air network 140. A radio wave transmitted from the ground mobile station 130 is relayed to the ground wireless station 120 via the upper-air network 140. Thus, packet data included in the radio wave transmitted from the ground mobile station 130 can be connected to a ground communication network.

Note that, in FIG. 1, a case where the ground communication network is a service network of the 5G mobile communication system has been described. However, the standards of the wireless communication system 100 do not have to be limited to 5G.

Note that, in FIG. 1, a case where all of the M upper-air wireless stations 110 in the wireless communication system 100 form the upper-air network 140 has been described. However, not all the upper-air wireless stations 110 necessarily have to form the upper-air network 140.

Furthermore, in FIG. 1, a case of uplink in which the packet data transmitted from the ground mobile station 130 to the upper-air wireless station 110 by radio waves is connected to the ground communication network has been described. However, there may be a case of downlink in which the ground mobile station 130 receives data. In a case of the downlink, communication is performed in a direction opposite to the above description.

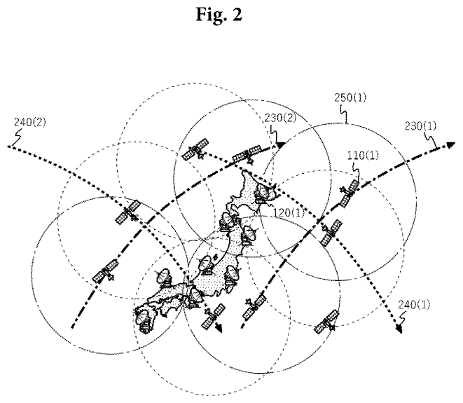

FIG. 2 is a schematic view illustrating a state in which the upper-air wireless stations move in the sky in the wireless communication system according to the first embodiment of the present disclosure. Here, only components necessary for the description are displayed from the configuration example of the wireless communication system 100 described in FIG. 1. In addition, it is assumed that the upper-air wireless stations 110 are satellite stations that move in the sky, such as LEO satellite stations.

FIG. 2 illustrates a state in which each of the plurality of upper-air wireless stations 110 travels on an orbit represented by any one of an ascending orbit 230(1), an ascending orbit 230(2), a descending orbit 240(1), and a descending orbit 240(2). For example, the upper-air wireless station 110 (1) is traveling on the ascending orbit 230(1). In such a case, the upper-air wireless station 110 that can be simultaneously viewed from a certain region on the ground changes from moment to moment.

In addition, in FIG. 2, a coverage area 250(1) is a wireless relay area of the upper-air wireless station 110(1). The upper-air wireless station 110(1) can establish a feeder link 210 with the ground wireless station 120(1) existing in the coverage area 250(1) of the upper-air wireless station 110(1) and can relay radio waves from the ground mobile station 130 in the area.

An installation place of the ground wireless station 120 is appropriately selected so that the plurality of upper-air wireless stations 110 can be viewed at the same time. In addition, in the upper-air wireless station 110, design of six Keplerian orbital elements, that is, a semimajor axis, an eccentricity, an inclination, a longitude of ascending node (right ascension of ascending node (RAAN)), an argument of perigee, and a mean anomaly, is optimized. As a result, even in a case where the currently working feeder link 210 is disconnected, for example, when the coverage area 250 of the upper-air wireless station 110 moving in the sky with time is separated from the currently working ground wireless station 120, a new line can be established.

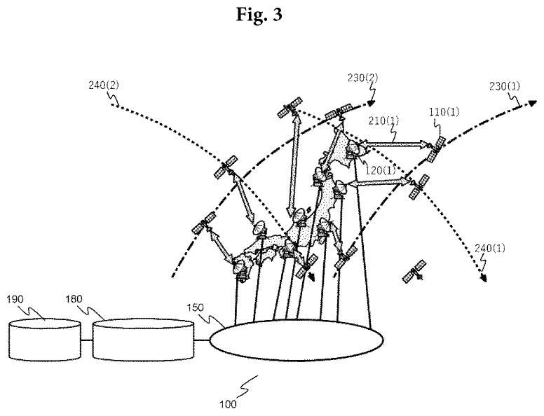

FIG. 3 is a view illustrating a role of the central control device according to the first embodiment of the present disclosure. Although FIG. 3 is similar to FIG. 2, one-to-one feeder links 210 are established between the plurality of upper-air wireless stations 110 and the plurality of ground wireless stations 120.

The central control device 180 determines combinations of the plurality of upper-air wireless stations 110 that move with time and the plurality of ground wireless stations 120, for which the feeder links 210 should bel established, so as not to overlap each other. Further, handover (hereinafter referred to as HO) control for switching the currently working feeder link 210 is performed based on the determined combinations. Here, a suitable combination is determined based on the weather prediction data distributed by the weather forecast data distribution system 190.

As described above with reference to FIGS. 2 and 3, in the wireless communication system 100 of the present disclosure, the central control device 180 determines a combination for establishing the feeder link 210 among the plurality of upper-air wireless stations 110 and the plurality of ground wireless stations 120 and performs HO control. Here, a suitable combination is determined based on the weather prediction data. As a result, it is possible to perform the HO control in consideration of influence of rainfall, or the like.

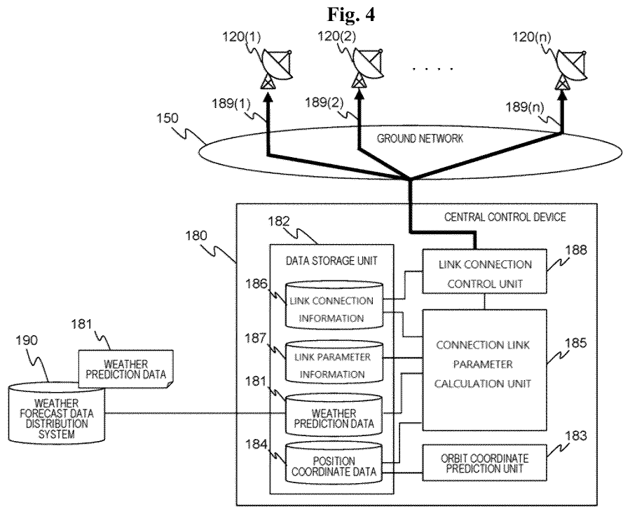

FIG. 4 is a block diagram illustrating a functional configuration example of the central control device according to the first embodiment of the present disclosure. The central control device 180 periodically downloads necessary weather prediction data 181 from the external weather forecast data distribution system 190 and stores the weather prediction data 181 in a data storage unit 182. The weather prediction data 181 is data indicated by numerical values of precipitation intensity, and the like. By accessing the external weather forecast data distribution system 190 as indicated in Non Patent Literature 3, it is possible to acquire high-resolution weather prediction data 181 with fine temporal and geographical divisions.

The data storage unit 182 is a storage device such as a hard disk drive or a solid state drive (SSD) that holds data calculated by the central control device 180, data acquired from the outside, or the like.

An orbit coordinate prediction unit 183 calculates and predicts future orbit coordinate positions of the upper-air wireless stations 110 from orbit observation data of the upper-air wireless stations 110 and stores the results in the data storage unit 182 as position coordinate data 184.

A connection link parameter calculation unit 185 derives a combination for establishing the feeder link 210 based on the weather prediction data 181, the position coordinate data 184, link connection information 186, and link parameter information 187 stored in the data storage unit 182. Furthermore, the connection link parameter calculation unit 185 performs calculation of predicting a signal degradation amount of a wireless transmission path in the feeder link 210 for each combination. The connection link parameter calculation unit 185 determines a combination for establishing the feeder link 210 among the plurality of upper-air wireless stations 110 and the plurality of ground wireless stations 120 based on the calculation result.

Here, in a case where there are m connectable upper-air wireless stations 110 with respect to the n ground wireless stations 120, the number of combinations of feeder links that can be established is calculated to be ₙPₘ in a case where n>m. On the other hand, in a case where m>n, the number of combinations is calculated as ₘPₙ.

In other words, the connection link parameter calculation unit 185 determines an optimum combination from ₙPₘ Of ₘPₙ combinations.

A link connection control unit 188 transmits a control message 189 including information on the optimum combination determined by the connection link parameter calculation unit 185 to each of the n ground wireless stations 120. The control message 189 is transmitted to each of the ground wireless stations 120 via the ground network.

In FIG. 4, the control messages 189 transmitted to the ground wireless station 120(1), the ground wireless station 120(2), . . . , the ground wireless station 120(n) are referred to as a control message 189(1), a control message 189(2), . . . , a control message 189(n), respectively.

As described above, in the wireless communication system 100 of the present disclosure, the central control device 180 performs HO control of the feeder link 210 for the ground wireless station 120. In the HO control, a suitable combination is selected from ₙPₘ or ₘPₙ combinations. In this manner, by performing the integrated connection control of the plurality of feeder links 210, it is possible to effectively use facilities of the ground wireless stations 120 and the upper-air wireless stations 110 included in the wireless communication system 100.

### Modification

Furthermore, in the present disclosure, the processing to be performed by the central control device 180 may be executed by a program using a computer including a CPU and a memory and storing the program in the memory. Alternatively, the program may be executed using an integrated circuit such as a field programmable gate array (FPGA). Note that the program may be provided by being recorded in a storage medium, or may be provided through a network.

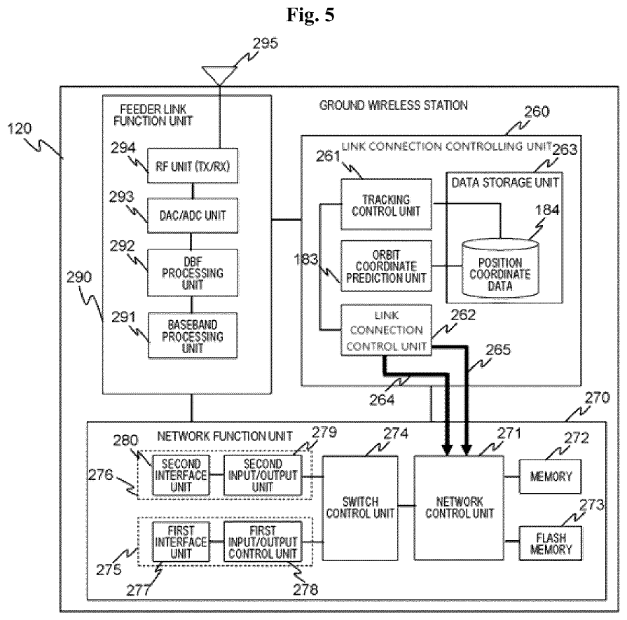

FIG. 5 is a block diagram illustrating a functional configuration example of the ground wireless station according to the first embodiment of the present disclosure. A link connection controlling unit 260 of the ground wireless station 120 includes a tracking control unit 261, an orbit coordinate prediction unit 183, a link connection control unit 262, and a data storage unit 263. The tracking control unit 261 is a portion that tracks and controls the upper-air wireless station 110 based on the position coordinate data 184. The orbit coordinate prediction unit 183 is similar to that in FIG. 4, and thus description thereof is omitted.

The link connection control unit 262 receives the control message 189 transmitted from the central control device 180. Further, the link connection control unit 262 performs HO of the feeder link based on the control message 189. In addition, in association with start of wireless connection, the link connection control unit 262 transmits a first control message 264 to the upper-air wireless station 110 that is a connection partner via a network function unit 270 and a feeder link function unit 290. As a result, it is possible to instruct the upper-air wireless station 110 that is the connection partner to start connection processing between the own station and the feeder link 210.

The link connection control unit 262 transmits a second control message 265 to a network control unit 271 in the network function unit 270 at the time of HO. The network control unit 271 executes a program based on the received second control message 265 and performs buffering control on a switch control unit 274.

If the ground wireless station 120 receives packet data to be transmitted to the upper-air wireless station 110 at a first port 275, the switch control unit 274 performs buffering based on control from the network control unit 271. Here, the packet data is held until the feeder link 210 is established. If the HO is completed and the new feeder link 210 is established, the packet data is output from a second port 276 to the feeder link function unit 290. In this manner, by performing packet buffering at the time of HO, it is possible to prevent the feeder link 210 from being temporarily disconnected and transmission packet loss from occurring.

The network function unit 270 of the ground wireless station 120 includes the network control unit 271, a memory 272, a flash memory 273, the switch control unit 274, the first port 275, and the second port 276. The network control unit 271 is a processor that executes a program, or the like, for implementing functions of the ground wireless station 120. In a case where the second control message 265 is received from the link connection control unit 262, the second control message 265 is output to the switch control unit 274 in order to transmit the second control message 265 to the upper-air wireless station 110.

The memory 272 corresponds to, for example, a volatile or non-volatile semiconductor memory such as a RAM or a ROM, a magnetic disk, or the like. The flash memory 273 is a non-volatile semiconductor memory. The memory 272 or the flash memory 273 stores a program for implementing functions of the ground wireless station 120. Further, transmission packet data is temporarily stored during the buffering described above.

The switch control unit 274 is a connection switch of a network based on the Ethernet (registered trademark) communication standards. The switch control unit 274 performs the buffering described above. In a case where the first control message 264 is received from the network control unit 271, the first control message 264 is output to the second port 276 so as to be transmitted to the upper-air wireless station 110.

The first port 275 includes a first interface unit 277 and a first input/output control unit 278. The first interface unit 277 transmits and receives packet data to and from the ground network 150 according to the Ethernet communication standards. The first input/output control unit 278 controls input/output of packet data to/from the switch control unit 274.

The second port 276 includes a second input/output control unit 279 and a second interface unit 280. The second input/output control unit 279 controls input/output of packet data to/from the switch control unit 274. The second interface unit 280 transmits and receives packet data to and from the feeder link function unit 290 according to the Ethernet communication standards.

The feeder link function unit 290 of the ground wireless station 120 includes a baseband processing unit 291, a digital beamforming (DBF) processing unit 292, a DAC/ADC unit 293, an RF unit 294, and an antenna 295. The baseband processing unit 291 performs processing such as modulation and encoding on a carrier wave that carries packet data received from the network function unit 270. The DBF processing unit 292 performs processing of shaping a beam of a carrier wave toward the upper-air wireless station 110 that is the connection partner.

The DAC/ADC unit 293 is a portion that performs analog conversion on a digitally modulated carrier wave. The RF unit 294 converts the carrier wave of an intermediate frequency subjected to the analog conversion into a radio wave of a radio frequency (RF). The antenna 295 is an antenna capable of simultaneously tracking a plurality of upper-air wireless stations 110 such as an active multi-beamforming array antenna that transmits and receives radio waves.

As described above, the ground wireless station 120 performs HO of the feeder link 210 to the upper-air wireless station 110 that is the connection partner. Further, the transmission packet is buffered until the HO is completed and a new feeder link 210 is established. As a result, it is possible to prevent packet loss from occurring between the start and the completion of the HO sequence.

### Modification

In the description of the network function unit 270 and the feeder link function unit 290 described above, a case where the ground wireless station 120 transmits the packet data to the upper-air wireless station 110 has been mainly described. Hereinafter, processing to be performed by these units in a case where the ground wireless station 120 receives packet data from the upper-air wireless station 110 will be described.

The network function unit 270 performs processing in a reverse order to that at the time of transmission. In other words, the second port receives the packet data from the feeder link function unit 290 and outputs the packet data to the switch control unit 274. The switch control unit 274 outputs the packet data input from the second port 276 to the first port 275. The first port 275 transmits the packet data input from the switch control unit 274 to the ground network 150.

The feeder link function unit 290 also performs processing in a reverse order to that of the above-described processing. In other words, the antenna 295 receives a radio wave. Further, the RF unit 294 converts the radio wave into an intermediate frequency. The DAC/ADC unit 293 converts the analog carrier wave into digital. The DBF processing unit 292 performs reception processing of the shaped beam. The baseband processing unit 291 performs processing such as demodulation and decoding of the carrier wave.

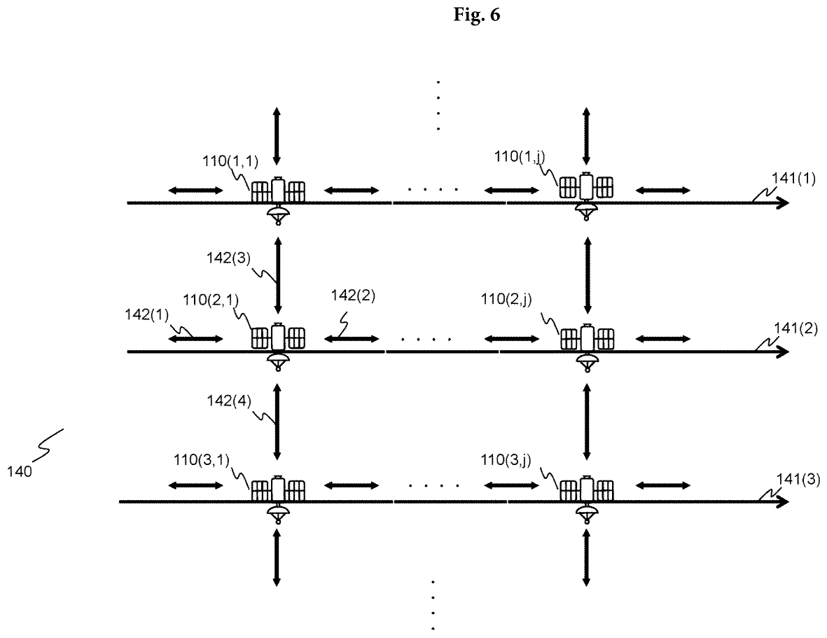

FIG. 6 is a configuration example of the upper-air network according to the first embodiment of the present disclosure. It is assumed here that the upper-air wireless station 110 is an LEO satellite station. As illustrated in FIG. 6, the upper-air network 140 includes a plurality of upper-air wireless stations 110 traveling on the same satellite orbit 141.

Here, with respect to the satellite orbit 141, a satellite orbit 141(1), a satellite orbit 141(2), a satellite orbit 141(3) . . . are described in order from the top of the drawing. Further, a matrix of the upper-air wireless station 110 traveling on a satellite orbit 141(i) is displayed as an upper-air wireless station 110(i, 1), an upper-air wireless station 110(i, 2), . . . , an upper-air wireless station 110(i, j) from the left in the drawing.

However, (number) at the end of the reference numeral is omitted for both the satellite orbit 141 and the upper-air wireless station 110, except for a case where it is necessary to specify the satellite orbit by adding (number) at the end of the reference numeral.

As illustrated in FIG. 6, the upper-air wireless station 110(2,1) connects an optical feeder link connection 142 to the upper-air wireless station 110(2,0) and the upper-air wireless station 110(2,2) close to the upper-air wireless station 110(2, 1) on the same orbit. Furthermore, the upper-air wireless station 110(2,1) connects the optical feeder link connection 142 also to the upper-air wireless station 110(1,1) and the upper-air wireless station 110(3,1) located at positions close to the upper-air wireless station 110(2,1) on close orbits.

In this manner, the upper-air wireless station 110 connects the optical feeder link connection 142 to the upper-air wireless station 110 close to the upper-air wireless station 110 on the same orbit and the upper-air wireless station 110 at a position close to the upper-air wireless station 110 on the close orbits. As a result, the upper-air network 140 of a grid topology can be formed.

### Modification

Note that the arrangement of the upper-air wireless station 110 is not limited to the example of FIG. 6 and may be suitably arranged according to a use environment of the upper-air network 140, and the like. In addition, the connection between the upper-air wireless stations 110 does not have to be the optical feeder link connection 142 and may be the feeder link connection by wireless communication.

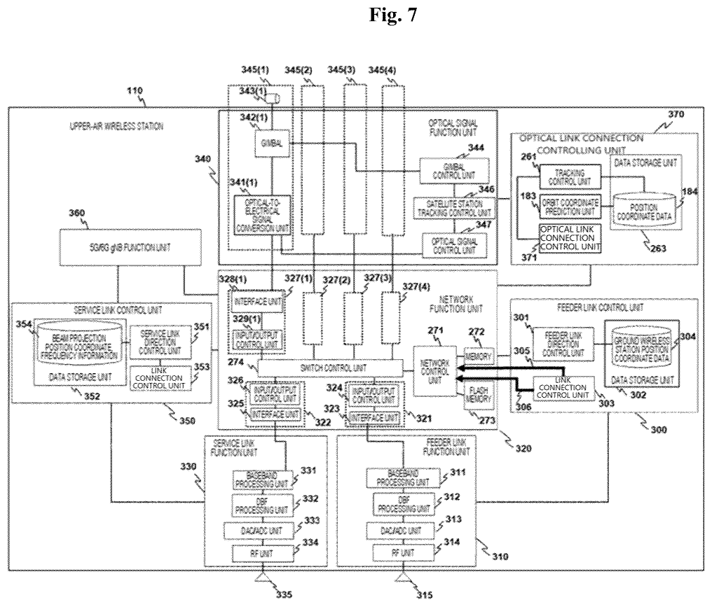

FIG. 7 is a block diagram illustrating a functional configuration example of a communication function of the upper-air wireless station according to the first embodiment of the present disclosure. It is assumed here, similarly to FIG. 6, that the upper-air wireless station 110 is an LEO satellite station.

A feeder link control unit 300 of the upper-air wireless station 110 includes a feeder link direction control unit 301, a data storage unit 302, and a link connection control unit 303. The feeder link direction control unit 301 controls a direction of the feeder link 210 based on ground wireless station position coordinate data 304 stored in the data storage unit 302.

The link connection control unit 303 receives the first control message 264 transmitted from the ground wireless station 120 via a feeder link function unit 310 and a network function unit 320. Further, the link connection control unit 303 performs HO for establishing the feeder link 210 with the ground wireless station 120 that is a transmission source based on the first control message 264.

The link connection control unit 303 transmits a third control message 305 to the network control unit 271 in the network function unit 320 at the time of HO. The network control unit 271 executes a program based on the received third control message 305 and performs buffering control on the switch control unit 274. As a result, it is possible to prevent packet loss from occurring between the start and the completion of the HO sequence also in the upper-air wireless station 110. Note that description of the switch control unit 274 is similar to that in FIG. 5, and thus, is omitted here.

The network function unit 320 of the upper-air wireless station 110 includes the network control unit 271, the memory 272, the flash memory 273, the switch control unit 274, a feeder link port 321, a service link port 322, and a plurality of optical signal ports 327. Description of the network control unit 271, the memory 272, the flash memory 273, and the switch control unit 274 is similar to that in FIG. 5, and thus is omitted.

The feeder link port 321 includes an interface unit 323 and an input/output control unit 324 and transmits and receives packet data to and from the feeder link function unit 310. In addition, the service link port 322 includes an interface unit 325 and an input/output control unit 326 and transmits and receives packet data to and from the service link function unit 330.

In addition, each of the plurality of optical signal ports 327 includes an interface unit 328 and an input/output control unit 329 and transmits and receives packet data to and from the optical signal function unit 340.

It is only necessary to read the ground network 150 as the feeder link function unit 310, the service link function unit 330, and the optical signal function unit 340 in the description of the first interface unit 277 of FIG. 5 as description of the interface unit 323, the interface unit 325, and the interface unit 328. Similarly, the description of the input/output control unit 324, the input/output control unit 326, and the input/output control unit 329 is similar to that of the first input/output control unit 278 in FIG. 5, and thus, is omitted.

The feeder link function unit 310 of the upper-air wireless station 110 transmits and receives radio waves to and from the ground wireless station 120. The description of each component of the feeder link function unit 310 is similar to that of the feeder link function unit 290 of FIG. 5, and thus, is omitted.

The service link control unit 350 of the upper-air wireless station 110 includes a service link direction control unit 351, a data storage unit 352, and a link connection control unit 353. The service link direction control unit 351 controls a service link direction based on a beam projection position coordinate and frequency information 354 stored in the data storage unit 352. The link connection control unit 353 controls connection of the service link 200 with the ground mobile station 130.

In addition, the service link function unit 330 of the upper-air wireless station 110 transmits and receives radio waves to and from the ground mobile station 130. The description here is similar to that of the feeder link function unit 290 of FIG. 5, and thus, is omitted.

A 5G/6G gNB function unit 360 of the upper-air wireless station 110 has a base station function in a communication system of the 5G/6G standards.

An optical link connection controlling unit 370 of the upper-air wireless station 110 includes the tracking control unit 261, the orbit coordinate prediction unit 183, the data storage unit 263, and an optical link connection control unit 371. The optical link connection control unit 371 performs connection control of the optical feeder link connection 142 for the upper-air wireless stations 110 close to the own station on the same orbit and the upper-air wireless stations 110 at positions close to the own station on the close orbits. Note that the description of the functions of the tracking control unit 261, the orbit coordinate prediction unit 183, and the data storage unit 263 is similar to that described in FIG. 5, and thus, is omitted.

The optical signal function unit 340 of the upper-air wireless station 110 is a portion that performs optical feeder link connection 142 with another upper-air wireless station 110 and performs optical signal communication. The optical signal function unit 340 includes a plurality of optical connection units 345 each including an optical-to-electrical signal conversion unit 341, a gimbal 342, and an optical signal transmission/reception unit 343. The optical-to-electrical signal conversion unit 341 receives data transmitted from the optical signal port 327 of the network function unit 320 and converts an electrical signal into an optical signal. The gimbal 342 is equipped with the optical signal transmission/reception unit 343 and holds a posture of the optical signal transmission/reception unit 343. The optical signal transmission/reception unit 343 is a portion that transmits the own packet data as an optical signal to a plurality of adjacent upper-air wireless stations 110.

A gimbal control unit 344 controls directions of the plurality of gimbals 342 based on position information, or the like, of the upper-air wireless stations 110 close to the own station acquired from a satellite station tracking control unit 346. An optical signal control unit 347 controls photoelectric conversion processing in the optical-to-electrical signal conversion unit 341.

As described above, the upper-air wireless station 110 of the present disclosure communicates with the ground wireless station 120, the ground mobile station 130, and the upper-air wireless station 110 close to the own station. In a case where the first control message 264 is received from the ground wireless station 120, HO for establishing the feeder link 210 with the ground wireless station 120 that is a transmission source is performed based on the received first control message 264. Furthermore, the transmission packet is buffered at the time of HO.

### Modification

In the above description of the feeder link control unit 300, it has been described that the link connection control unit 303 performs the HO based on the first control message 264 received from the ground wireless station 120. However, even in a case where there is no first control message 264, the upper-air wireless station 110 may voluntarily perform HO of the feeder link 210 to the ground wireless station 120 by a built-in link connection control program.

In this manner, in a case where the upper-air wireless station 110 voluntarily performs HO, a fourth control message 306 may be transmitted to the ground wireless station 120 that is the connection partner via the network function unit 320 and the feeder link function unit 310 in association with start of wireless connection. As a result, it is possible to instruct the ground wireless station 120 that is the connection partner to start connection processing between the own station and the feeder link 210.

Note that, in the description of the optical signal function unit 340 described above, a case where packet data is transmitted by the optical signal communication to another upper-air wireless station 110 close to the upper-air wireless station 110 has been described. On the other hand, in a case where packet data is received from another upper-air wireless station 110, the optical signal function unit 340 performs processing in a reverse order to that at the time of transmission. In other words, the optical signal transmission/reception unit 343 receives packet data as an optical signal. The optical-to-electrical signal conversion unit 341 performs processing of converting an optical signal into an electrical signal and inputting the electrical signal to the optical signal port 327 of the network function unit 320.

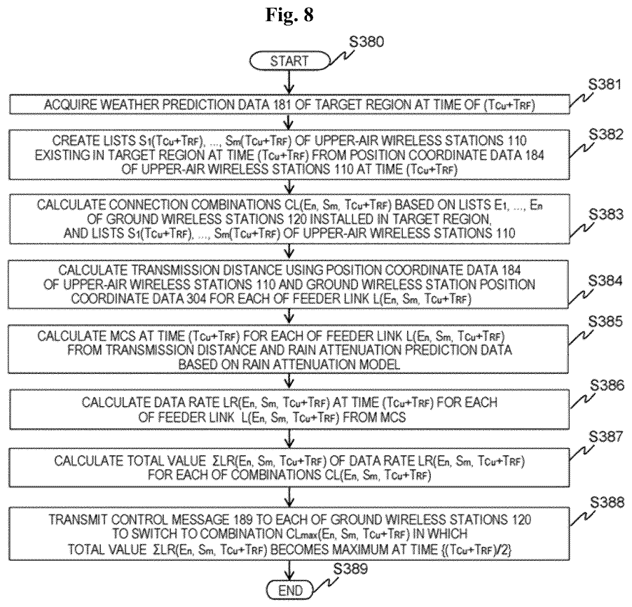

FIG. 8 is a flowchart of processing to be executed by the central control device according to the first embodiment of the present disclosure. Here, it is assumed that there are n ground wireless stations 120 that can be connected to the m upper-air wireless stations 110. First, the central control device 180 starts processing (step S380). Next, the weather prediction data 181 of a target region at the time (T_{cu}+T_{RF}), which is the current time after the lapse of time T_{RF} from T_{c}_{ᵤ}, is acquired from the weather forecast data distribution system 190 (step S381). Further, lists S₁(T_{Cu}+T_{RF}), . . . , Sₘ(T_{Cu}+T_{RF}) of the upper-air wireless stations 110 existing in the target region at the time (T_{Cu}+T_{RF}) are created from the position coordinate data 184 of the upper-air wireless stations 110 at the time (T_{Cu}+T_{RF}) (step S382).

Next, based on the lists E₁, . . . , En of the ground wireless stations 120 installed in the target region and the lists S₁(T_{Cu}+T_{RF}), . . . , Sₘ(T_{Cu}+T_{RF}) of the upper-air wireless stations 110, combinations CL(Eₙ, Sₘ, T_{Cu}+T_{RF}) thereof are calculated (step S383). Here, each of the one-to-one feeder links represented by the connection combinations CL(Eₙ, Sₘ, T_{Cu}+T_{RF}) is denoted by L(Eₙ, Sₘ, T_{Cu}+T_{RF}).

Next, a transmission distance is calculated for each of the feeder links L(Eₙ, Sₘ, T_{Cu}+T_{RF}) using the position coordinate data 184 of the upper-air wireless stations 110 and the ground wireless station position coordinate data 304 (step S384). A modulation and coding scheme (MCS) at the time (T_{Cu}+T_{RF}) is calculated for each of the feeder links L(Eₙ, Sₘ, T_{Cu}+T_{RF}) from the transmission distance and rain attenuation prediction data based on a rain attenuation model (step S385).

Further, data rates LR(Eₙ, Sₘ, T_{Cu}+T_{RF}) at the time (T_{Cu}+T_{RF}) is calculated for each of the feeder links L(Eₙ, Sₘ, T_{Cu}+T_{RF}) from the calculated MCS (step S386).

Further, a total value ΣLR (Eₙ, Sₘ, T_{Cu}+T_{RF}) of the data rates LR(Eₙ, Sₘ, T_{Cu}+T_{RF}) is calculated for each of the combinations CL(Eₙ, Sₘ, T_{Cu}+T_{RF}) (step S387). Further, in order to switch to a combination CLₘₐₓ(Eₙ, Sₘ, T_{Cu}+T_{RF}) in which the total value ΣLR(Eₙ, Sₘ, T_{Cu}+T_{RF}) becomes a maximum at the time {(T_{Cu}+T_{RF})/2}, the control message 189 is transmitted to each of the ground wireless stations 120 (step S388). Finally, the processing ends (step S389).

As described above in the flowchart, the central control device 180 can determine the combination that maximizes a sum of the communication data rates of the feeder links in which the m upper-air wireless stations 110 and the n ground wireless stations 120 form a multi-session configuration. Further, the HO control can be performed based on this combination.

### Modification

Note that the processing of the above flowchart does not have to be necessarily performed by the central control device. For example, the processing may be performed in any one of the ground wireless stations 120. In this case, it is only necessary to, in step S388, transmit the control message including information on the combination CLₘₐₓ(Eₙ, Sₘ, T_{Cu}+T_{RF}) from the ground wireless station 120 that has performed the above-described flowchart to the other ground wireless stations 120.

As described above, according to the present disclosure, it is possible to provide the wireless communication system 100, the central control device 180, and the wireless communication method capable of effectively using facilities of the ground wireless stations 120 and the upper-air wireless stations 110 and improving a data rate of wireless communication in the NTN.

### Correspondence With Terms Used in Claims

Processing of calculating combinations of the feeder links 210 between the ground wireless stations 120 and the upper-air wireless stations 110 to be performed by the wireless communication system 100 of the present disclosure is referred to as combination calculation processing. The combination calculation processing is, for example, the processing in step S383. The processing of calculating a data rate for each of the feeder links 210 indicated by the combinations is referred to as data rate calculation processing. The data rate calculation processing is, for example, the processing in step S386. Furthermore, processing of calculating a total value of the data rates for each of the combinations is referred to as total value calculation processing.

The total value calculation processing is, for example, the processing in step S387.

Further, processing of switching the feeder link to a combination in which the total value becomes a maximum is referred to as link switching processing. The link switching processing is, for example, the processing in step S388, the processing to be performed by the link connection controlling unit 260 of the ground wireless station 120, and the processing to be performed by the feeder link control unit 300 of the upper-air wireless station 110.

### REFERENCE SIGNS LIST

Wireless communication system 100
Upper-air wireless station 110
Ground wireless station 120
Ground mobile station 130
Upper-air network 140
Satellite orbit 141
Optical feeder link connection 142
Ground network 150
UPF 160
Core network 170
DN 175
Central control device 180
Weather prediction data 181
Data storage unit 182
Orbit coordinate prediction unit 183
Position coordinate data 184
Connection link parameter calculation unit 185
Link connection information 186
Link parameter information 187
Link connection control unit 188
Control message 189
Weather forecast data distribution system 190
Service link 200
Feeder link 210
Ascending orbit 230
Descending orbit 240
Coverage area 250
Link connection controlling unit 260
Tracking control unit 261
Link connection control unit 262
Data storage unit 263
First control message 264
Second control message 265
Network function unit 270
Network control unit 271
Memory 272
Flash memory 273
Switch control unit 274
First port 275
Second port 276
First interface unit 277
First input/output control unit 278
Second input/output control unit 279
Second interface unit 280
Feeder link function unit 290
Baseband processing unit 291
DBF processing unit 292
DAC/ADC unit 293
RF unit 294
Antenna 295
Feeder link control unit 300
Feeder link direction control unit 301
Data storage unit 302
Link connection control unit 303
Ground wireless station position coordinate data 304
Third control message 305
Fourth control message 306
Feeder link function unit 310
Baseband processing unit 311
DBF processing unit 312
DAC/ADC unit 313
RF unit 314
Antenna 315
Network function unit 320
Feeder link port 321
Service link port 322
Interface unit 323
Input/output control unit 324
Interface unit 325
Input/output control unit 326
Optical signal port 327
Interface unit 328
Input/output control unit 329
Service link function unit 330
Baseband processing unit 331
DBF processing unit 332
DAC/ADC unit 333
RF unit 334
Antenna 335
Optical signal function unit 340
Optical-to-electrical signal conversion unit 341
Gimbal 342
Optical signal transmission/reception unit 343
Optical connection unit 345
Gimbal control unit 344
Satellite station tracking control unit 346
Optical signal control unit 347
Service link control unit 350
Service link direction control unit 351
Data storage unit 352
Link connection control unit 353
Beam projection position coordinate, frequency information 354
5G/6G gNB function unit 360
Optical link connection controlling unit 370
Optical link connection control unit 371

1. A wireless communication system that performs communication using a non-terrestrial network, the wireless communication system comprising:
a plurality of ground wireless stations; and
a plurality of upper-air wireless stations that perform wireless communication with the ground wireless stations by one-to-one feeder links while moving in the sky including outer space or while moving in the sky including outer space but being relatively stationary with respect to the ground,
wherein the wireless communication system is configured to execute:
calculating combinations of the feeder links between the ground wireless stations and the upper-air wireless stations;
calculating data rates respectively for the feeder links indicated by the combinations;
calculating a total value of the data rates for each of the combinations; and
switching feeder link to the combination in which the total value becomes a maximum.

2. The wireless communication system according to claim 1, further comprising:
a central controller, wherein
the central controller is configured to execute:
calculating the combination;
calculating the data rate;
calculating the total value; and transmitting a control message including information on the combination in which the total value becomes a maximum to the plurality of ground wireless stations, and
the plurality of ground wireless stations are configured to execute switching feeder link based on the control message.

3. The wireless communication system according to claim 1, wherein
the calculation of the data rate includes:
acquiring weather prediction data indicated by a numerical value;
calculating a transmission distance for each of the feeder links indicated by the combinations; and
calculating a data rate for each of the feeder links indicated by the combinations based on the weather prediction data and the transmission distance.

4. The wireless communication system according to claim 1, wherein in the feeder link switching, the ground wireless station and the upper-air wireless station perform buffering of transmission packet data until feeder link switching is completed and a new feeder link is established.

5. The wireless communication system according to claim 1, wherein the feeder link switching includes:
the ground wireless station transmitting a control message to the upper-air wireless station that is a connection partner in association with start of wireless connection; and
the upper-air wireless station that is the connection partner starting wireless connection to the ground wireless station that is a transmission source based on the control message.

6. The wireless communication system according to claim 1, wherein any two or more of the plurality of upper-air wireless stations are connected to the upper-air wireless stations close to the any two or more of the plurality of upper-air wireless stations by optical signal communication or wireless communication and relay radio waves transmitted from the ground wireless station or ground mobile stations.

7. A central controller that controls feeder links to be established between:
a plurality of ground wireless stations; and
upper-air wireless stations that perform wireless communication while moving in the sky including outer space or while moving in the sky including outer space but being relatively stationary with respect to the ground,
the central controller being configured to execute:
calculating combinations of the feeder links between the ground wireless stations and the upper-air wireless stations;
calculating data rates respectively for the feeder links indicated by the combinations;
calculating a total value of the data rates for each of the combinations; and
transmitting a control message including information on the combination in which the total value becomes a maximum to the plurality of ground wireless stations.

8. A wireless communication method for performing communication using a non-terrestrial network including:
a plurality of ground wireless stations; and
a plurality of upper-air wireless stations that perform wireless communication with the ground wireless stations by one-to-one feeder links while moving in the sky including outer space or while moving in the sky including outer space but being relatively stationary with respect to the ground,
the wireless communication method comprising:
calculating combinations of the feeder links between the ground wireless stations and the upper-air wireless stations;
calculating data rates respectively for the feeder links indicated by the combinations;
calculating a total value of the data rates for each of the combinations; and
switching feeder link to the combination in which the total value becomes a maximum.

9. The wireless communication system according to claim 2, wherein
the calculation of the data rate includes:
acquiring weather prediction data indicated by a numerical value;
calculating a transmission distance for each of the feeder links indicated by the combinations; and
calculating a data rate for each of the feeder links indicated by the combinations based on the weather prediction data and the transmission distance.

10. The wireless communication system according to claim 4, wherein
the feeder link switching includes:
the ground wireless station transmitting a control message to the upper-air wireless station that is a connection partner in association with start of wireless connection; and
the upper-air wireless station that is the connection partner starting wireless connection to the ground wireless station that is a transmission source based on the control message.
